(19) United States
(12) Patent Application Publication
(10) Pub. No.: US 2016/0216863 A1
(43) Pub. Date: Jul. 28, 2016

(54) CORKSCREW USER INTERFACE LINKING CONTENT AND CURATORS

(71) Applicant: Sony Corporation, Tokyo (JP)

(72) Inventors: Steven Friedlander, Escondido, CA (US); David Young, San Diego, CA (US)

(21) Appl. No.: 14/606,525

(22) Filed: Jan. 27, 2015

(51) Int. Cl. G06F 3/0481; G06F 3/0484

(52) U.S. Cl. CPC G06F 3/04817; G06F 3/04842

(57) ABSTRACT

A user interface (UI) links additional content and curators of videos by connecting dots with lines to show the connections. The lines can fade out as to not busy the interface. Content may be linked using sidebars, icons, tabs, buttons. When lines are used, lines are depicted on the UI connecting a first video icon to icons of other linked videos or curators that have connections to the first video. When a content icon is selected, a connection opens a new “circle” of content on the UI which can then have connections from the selected content. In this way a user can discover new content that has relevancy to what the user is currently viewing. The lines can time out to clean up the look of the UI. When navigating or swiping the screen the lines can reappear.

### FIELD OF THE INVENTION

The application relates generally to user interfaces (UIs) that intuitively link related content and content curators.

### BACKGROUND OF THE INVENTION

A computer ecosystem, or digital ecosystem, is an adaptive and distributed socio-technical system that is characterized by its sustainability, self-organization, and scalability. Inspired by environmental ecosystems, which consist of biotic and abiotic components that interact through nutrient cycles and energy flows, complete computer ecosystems consist of hardware, software, and services that in some cases may be provided by one company, such as Sony. The goal of each computer ecosystem is to provide consumers with everything that may be desired, at least in part services and/or software that may be exchanged via the internet. Moreover, interconnectedness and sharing among elements of an ecosystem, such as applications within a computing cloud, provides consumers with increased capability to organize and access data and presents itself as the future characteristic of efficient integrative ecosystems.

Two general types of computer ecosystems exist: vertical and horizontal computer ecosystems. In the vertical approach, virtually all aspects of the ecosystem are owned and controlled by one company, and are specifically designed to seamlessly interact with one another. Horizontal ecosystems, one the other hand, integrate aspects such as hardware and software that are created by other entities into one unified ecosystem. The horizontal approach allows for greater variety of input from consumers and manufactures, increasing the capacity for novel innovations and adaptations to changing demands.

### SUMMARY OF THE INVENTION

An example ecosystem that is pertinent here is a network that provides audio video (AV) content which may be related to additional content and/or to particular content curators.

A computer device has at least one computer readable storage medium with instructions executable by a processor and at least one processor configured for accessing the computer readable storage medium to execute the instructions to configure the processor for presenting on a display a user interface (UI). The UI includes a current video icon representing a current video input to the display. The instructions when executed by the processor configure the processor for presenting on the UI, around the current video icon, an arrangement of plural first tier icons. The first tier icons include content icons each representing a respective content related to the current video, and at least one curator icon representing a respective curator related to the current. The instructions when executed by the processor configure the processor for presenting on the UI at least one second tier icon and at least one line extending from one of the first tier icons to the second tier icon, with the second tier icon representing subject matter including content and/or a curator related to content represented by the first tier icon from which the line extends. Moreover, the instructions when executed by the processor configure the processor for receiving a user selection of the second tier icon, and responsive to the selection, presenting around the second tier icon plural third tier icons each respectively related to a content or curator related to the subject matter represented by the second tier icon.

In examples, a content icon has a different shape than a curator icon. A curator icon may represent a provider of content.

In some implementations the instructions when executed by the processor configure the processor for, responsive to the selection of the second tier icon, removing the arrangement of first tier icons from the UI and moving the current video icon. The instructions when executed by the processor may also configure the processor for, responsive to the selection of the second tier icon, changing video input to the display to content represented by the second tier icon. The arrangement of first tier icons can define a circle and a content icon can include a rectangle, whereas a curator icon can include a circle.

In another aspect, a computer device includes at least one computer readable storage medium that is not a carrier wave and that has instructions executable by a processor to configure the processor to present on a display a user interface (UI) having a current content icon representing a current content input to the display. The instructions when executed by the processor configure the processor to present an arrangement of plural first tier icons around the current content icon, with each first tier icon representing respective subject matter related to the current content. Also, the instructions when executed by the processor configure the processor to present on the UI at least one second tier icon and at least one line extending from one of the first tier icons to the second tier icon. The second tier icon represents subject matter related to content represented by the first tier icon from which the line extends. Moreover, the instructions when executed by the processor configure the processor to receive a user selection of the second tier icon, and responsive to the selection, present around the second tier icon plural third tier icons each respectively related to subject matter in turn related to the subject matter represented by the second tier icon.

In another aspect, a method includes presenting on a display a user interface (UI) that links additional content and curators of videos by connecting, using lines, first tier icons to show connections to second tier icons also presented on the UI. The first tier icons surround a current content icon. The method includes removing the lines from the UI after a predetermined period and receiving selection of a second tier icon on the UI. Responsive to the selection, a new circle of content icons is opened on the UI, at least some of which content icons are depicted on the UI as having connections to tertiary icons representing respective subject matter such that a user can discover new content that has relevancy to what the user is currently viewing.

The details of the present invention, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system including an example in accordance with present principles;

FIG. 2 is a flow chart of example logic for grouping content and curators;

FIG. 3 is a screen shot off an example user interface (UI) illustrating relationships between a current video and other content and curators; and

FIGS. 4-9 are schematic views if example screen shots for browsing through content with intuitive related content/curator indications shown.

### DETAILED DESCRIPTION

This disclosure relates generally to computer ecosystems including aspects of consumer electronics (CE) device based user information in computer ecosystems. A system herein may include server and client components, connected over a network such that data may be exchanged between the client and server components. The client components may include one or more computing devices including portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, operating systems from Microsoft, or a Unix operating system, or operating systems produced by Apple Computer or Google. These operating environments may be used to execute one or more browsing programs, such as a browser made by Microsoft or Google or Mozilla or other browser program that can access web applications hosted by the Internet servers discussed below.

Servers may include one or more processors executing instructions that configure the servers to receive and transmit data over a network such as the Internet. Or, a client and server can be connected over a local intranet or a virtual private network. A server or controller may be instantiated by a game console such as a Sony Playstation (trade-marked), a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below cars be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented is software, can be written in an appropriate language such as but not limited to C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires. Such connections may include wireless communication connections including infrared and radio.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least, one of A, B, or C” and “a system having at least one of A, B, C”) includes systems that have A alone, B alone, C alone, A and B together, A and C together, B and C together, and/or A, B, and C together, etc.

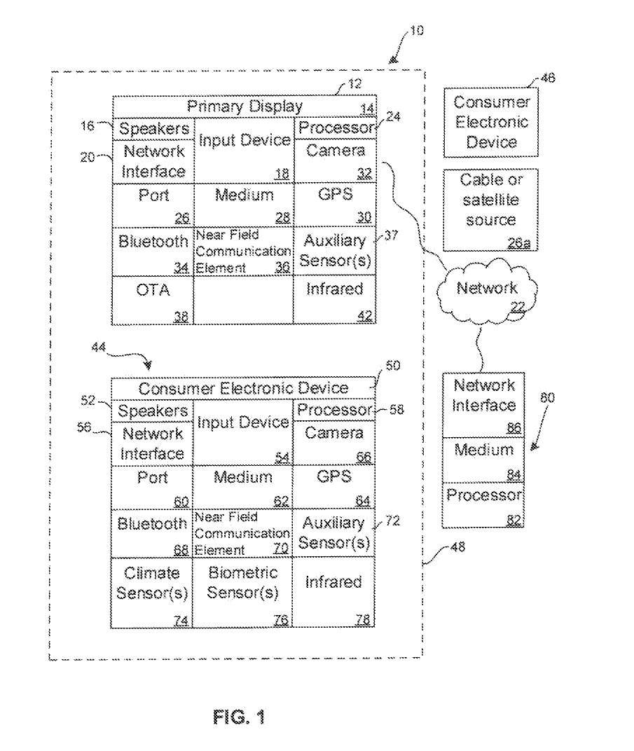

Now specifically referring to FIG. 1, an example ecosystem 10 is shown, which may include one or more of the example devices mentioned above and described further below in accordance with present principles. The first of the example devices included in the system 10 is a consumer electronics (CE) device configured as an example primary display device, and in the embodiment shown is an audio video display device (AVDD) 12 such as but not limited to an Internet-enabled TV with a TV tuner (equivalently, set top box controlling a TV). However, the AVDD 12 alternatively may be an appliance or household item, e.g. computerized Internet enabled refrigerator, washer, or dryer. The AVDD 12 alternatively may also be a computerized Internet enabled (“smart”) telephone, a tablet computer, a notebook computer, a wearable computerized device such as e.g. computerized Internet-enabled watch, a computerized Internet-enabled bracelet, other computerized Internet-enabled devices, a computerized Internet-enabled music player, computerized Internet-enabled head phones, a computerized Internet-enabled implantable device such as an implantable skin device, etc. Regardless, it is to be understood that the AVDD 12 is configured to undertake present principles (e.g. communicate with other CE devices to undertake present principles, execute the logic described herein, and perform any other functions and/or operations described herein).

Accordingly, to undertake such principles the AVDD 12 can be established by some or all of the components shown in FIG. 1. For example, the AVDD 12 can include one or more displays 14 that may be implemented by a high definition or ultra-high definition “4K” or higher flat screen and that may be touch-enabled for receiving user input signals via touches on the display. The AVDD 12 may include one or more speakers 16 for outputting audio in accordance with present principles, and at least one additional input device 18 such as e.g. an audio receiver/microphone for e.g. entering audible commands to the AVDD 12 to control the AVDD 12. The example AVDD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVDD 12 to undertake present principles, including the other elements of the AVDD 12 described herein such as e.g. controlling the display 14 to present images thereon and receiving input therefrom. Furthermore, note the network interface 20 may be, e.g., a wired or wireless modem or router, or other appropriate interface such as, e.g., a wireless telephony transceiver, or Wi-Fi transceiver as mentioned above, etc.

In addition to the foregoing, the AVDD 12 may also include one or more input ports 26 such as, e.g., a high definition multimedia interface (HDMI) port or a USB port to physically connect (e.g. using a wired connection) to another CE device and/or a headphone port to connect headphones to the AVDD 12 for presentation of audio from the AVDD 12 to a user through the headphones. For example, the input port 26 may be connected via wire or wirelessly to a cable or satellite source 26a of audio video content. Thus, the source 26a may be, e.g., a separate or integrated set top box, or a satellite receiver. Or, the source 26a may be a game console or disk player containing content that might be regarded by a user as a favorite for channel assignation purposes described further below.

The AVDD 12 may further include one or more tangible computer readable storage medium 28 such as disk-based or solid state storage, in some cases embodied in the chassis of the AVDD as standalone devices or as a personal video recording device (PVR) or video disk player either internal or external to the chassis of the AVDD for playing back AV programs. Also in some embodiments, the AVDD 12 can include a position or location receiver such as but not limited to a cellphone receiver, GPS receiver and/or altimeter 30 that is configured to e.g. receive geographic position information from at least one satellite or cellphone tower and provide the information to the processor 24 and/or determine an altitude at which the AVDD 12 is disposed in conjunction with the processor 24. However, it is to be understood that that another suitable position receiver other than a cellphone receiver. GPS receiver and/or altimeter may be used in accordance with present principles to e.g. determine the location of the AVDD 12 in e.g. all three dimensions.

Continuing the description of the AVDD 12, in some embodiments the AVDD 12 may include one or more cameras 32 that may be, e.g., a thermal imaging camera, a digital camera such as a webcam, and/or a camera integrated into the AVDD 12 and controllable by the processor 24 to gather pictures/images and/or video in accordance with present principles. Also included on the AVDD 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the AVDD 12 may include one or more auxiliary sensors 37 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the processor 24. The AVDD 12 may include an over-the-air TV broadcast port 38 for receiving OTH TV broadcasts providing input to the processor 24. In addition to the foregoing, it is noted that the AVDD 12 may also include an infrared (IR) transmitter and/or IR receiver and/or IR transceiver 42 such as an IR data association (IRDA) device. A battery (not shown) may be provided for powering the AVDD 12.

Still referring to FIG. 1, in addition to the AVDD 12, the system 10 may include one or more other CE device types. In one example, a first CE device 44 may be used to control the display via commands sent through the below-described server while a second CE device 46 may include similar components as the first CE device 44 and hence will not be discussed in detail. In the example shown, only two CE devices 44, 46 are shown, it being understood that fewer or greater devices may be used.

In the example shown, to illustrate present principles all three devices 12, 44, 46 are assumed to be members of an entertainment network in, e.g., a home, or at least to be present in proximity to each other in a location such as a house. However, for present principles are not limited to a particular location, illustrated by dashed lines 48, unless explicitly claimed otherwise.

The example non-limiting first CE device 44 may be established by any one of the above-mentioned devices, for example, a portable wireless laptop computer or notebook computer, and accordingly may have one or more of the components described below. The second CE device 46 without limitation may be established by a video disk player such as a Blu-ray player, a game console, and the like. The first CE device 44 may be a remote control (RC) for, e.g., issuing AV play and pause commands to the AVDD 12, or it may be a more sophisticated device such as a tablet computer, a wireless telephone, etc.

Accordingly, the first CE device 44 may include one or more displays 50 that may be touch-enabled for receiving user input signals via touches on the display. The first CE device 44 may include one or more speakers 52 for outputting audio in accordance with present principles, and at least one additional input device 54 such as e.g. an audio receiver/microphone for e.g. entering audible commands to the first CE device 44 to control the device 44. The example first CE device 44 may also include one or more network interfaces 56 for communication over the network 22 under control of one or more CE device processors 58. Thus, the interface 56 may be, without limitation, a Wi-Fi transceiver, which is an example of a wireless computer network interface, including mesh network interfaces. It is to be understood that the processor 58 controls the first CE device 44 to undertake present principles, including the other elements of the first CE device 44 described herein such as e.g. controlling the display 50 to present images thereon and receiving input therefrom. Furthermore, note the network interface 56 may be, e.g., a wired or wireless modem or router, or other appropriate interface such as, e.g., a wireless telephony transceiver, or Wi-Fi transceiver as mentioned above, etc.

In addition to the foregoing, the first CE device 44 may also include one or more input ports 60 such as, e.g., a HDMI port or a USB port to physically connect (e.g. using a wired connection) to another CE device and/or a headphone port to connect headphones to the first CE device 44 for presentation of audio from the first CE device 44 to a user through the headphones. The first CE device 44 may further include one or more tangible computer readable storage medium 62 such as disk-based or solid state storage. Also in some embodiments, the first CE device 44 can include a position or location receiver such as but not limited to a cellphone and/or GPS receiver and/or altimeter 64 that is configured to e.g. receive geographic position information from at least one satellite and/or cell tower, using triangulation, and provide the information to the CE device processor 58 and/or determine an altitude at which the first CE device 44 is disposed in conjunction with the CE device processor 58. However, it is to be understood that that another suitable position receiver other than a cellphone and/or GPS receiver and/or altimeter may be used in accordance with present principles to e.g. determine the location of the first CE device 44 in e.g. all three dimensions.

Continuing the description of the first CE device 44, in some embodiments the first CE device 44 may include one or more cameras 66 that may be, e.g., a thermal imaging camera, a digital camera such as a webcam, and/or a camera integrated into the first CE device 44 and controllable by the CE device processor 58 to gather pictures/images and/or video in accordance with present principles. Also included on the first CE device 44 may be a Bluetooth transceiver 68 and other Near Field Communication (NFC) element 70 for communication with other devices using Bluetooth and/or NFC technology, respectively. An example NFC element can be a radio frequency identification (RFID) element.

Further still, the first CE device 44 may include one or more auxiliary sensors 72 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the CE device processor 58. The first CE device 44 may include still oilier sensors such as e.g. one or more climate sensors 74 (e.g. barometers, humidity sensors, wind sensors, light sensors, temperature sensors, etc.) and/or one or more biometric sensors 76 providing input to the CE device processor 58. In addition to the foregoing, it is noted that in some embodiments the first CE device 44 may also include an infrared (IR) transmitter and/or IR receiver and/or IR transceiver 42 such as an IR data association (IRDA) device. A battery (not shown) may be provided for powering the first CE device 44. The CE device 44 may communicate with the AVDD 12 through any of the above-described communication modes and related components.

The second CE device 46 may include some or all of the components shown for the CE device 44.

Now in reference to the afore-mentioned at least one server 80, it includes at least one server processor 82, at least one tangible computer readable storage medium 84 such as disk-based or solid state storage, and at least one network interface 86 that, under control of the server processor 82, allows for communication with the other devices of FIG. 1 over the network 22, and indeed may facilitate communication between servers and client devices in accordance with present principles. Note that the network interface 86 may be, e.g., a wired or wireless modem or router, Wi-Fi transceiver, or other appropriate interface such as, e.g., a wireless telephony transceiver.

Accordingly, in some embodiments the server 80 may be an Internet server, and may include and perform “cloud” functions such that the devices of the system 10 may access a “cloud” environment via the server 80 in example embodiments. Or, the server 80 may be implemented by a game console or other computer in the same room as the other devices shown in FIG. 1 or nearby.

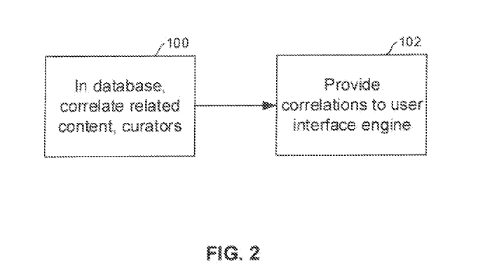

Now referring to FIG. 2, at block 100 content is correlated to curators of that content in a database. The database may be a cloud database such as on the server 80 or it may be local to the AVDD 12 or it may be distributed therebetween. The correlation may be done manually by associating content with its curator or it may be done automatically by reading metadata in the content to extract the curator information therefrom or simply by associating and storing such metadata with the content. A curator of content refers to a provider of content, typically a producer such as a movie studio or movie producer personage. A curator may alternatively refer to a content, or movie service.

In any case, at block 102 of FIG. 2 the correlations are provided to a user interface (UI) engine executed by, e.g., the processor of the AVDD, for purposes to be shortly disclosed.

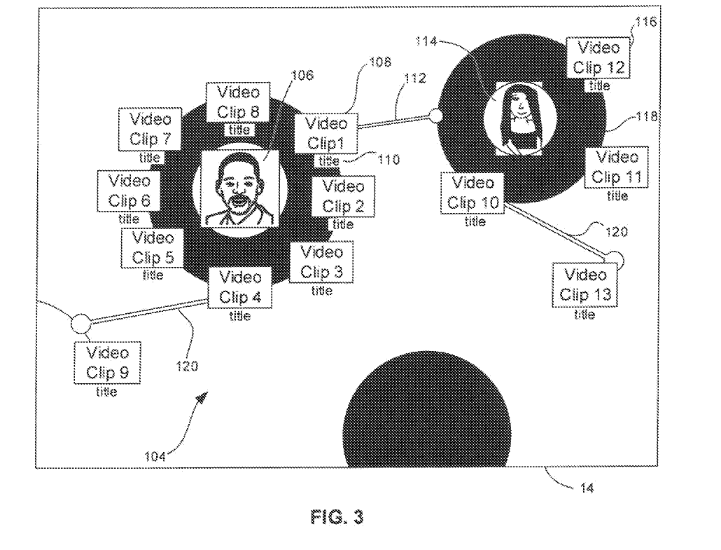

Turning now to FIG. 3, a UI 104 is shown that may be presented on a CE device display such as the display 14 of the AVDD 12 upon invocation of the UI, e.g., by a user selecting the UI for presentation from a menu. As shown, a current video icon 106 representing a current video input to the display is presented. The current video icon may be a still picture or the currently playing video. When it is a still picture it may be an image of the lead actor, for instance, as selected by the curator of the video or as selected from a key frame using face recognition software to locate the name of the lead actor as obtained from metadata accompanying the video, as but two examples.

Around the current video icon 106 is an arrangement of plural first tier icons 108. The arrangement may be a circular layout of icons 108 as shown and adjacent icons may be connected by arcuate lines 110.

The first tier icons 106 include content icons, each representing a respective content related to the current video. The first tier icons are smaller in size than the current video icon 106 in the example shown. Although not shown in FIG. 3 but described further below, the first tier icons 106 may also include at least one curator icon representing a respective curator related to the current video. Content icons may have different shapes than curator icons. For example, content icons may have rectilinear peripheries while curator icons may have circular peripheries.

The content represented by the first tier icons 108 may be correlated as being related to the video represented by the current video icon 106 by inference or by direct correlation. For example, related videos may be grouped as such in a database manually by an administrator. Or, related videos may be identified as such using metadata-driven rules, such as “related if one or more actors are common to both pieces of content” or “related if from the same curator” or “related if the number of terms in metadata of one video equals a threshold number of those same terms in metadata of a second video.”

Additionally, the UI 104 may include one or more second tier icons 114 with a visible line 112 extending from one of the first tier icons 108 to the second tier icon 114 to indicate a relation between the subject matter represented by the respective first and second tier icons. Thus, the second tier icon 114 which is connected by a line 112 to a first tier icon 108 represents subject matter including content and/or a curator related to content represented by the first tier icon from which the line 112 extends.

Furthermore, third tier icons 116 may surround the second tier icon 114 and may be connected to adjacent third tier icons by arcuate lines 118. The third tier icons 116 represent content and/or curators related to the content represented by the second tier icon 114. Lines 120 may extend from third tier icons to additional icons representing content related to the content of the third tier icon from which the line 120 extends.

A user can select any first tier icon 108 to enlarge it and move it to the center of an arrangement of its own second tier icons to replace the current video icon 106 shown in FIG. 3. Selection may be done via touch screen selection, remote control selection, or other appropriate selection method. Likewise, a user can select a second tier icon 114 to cause to be presented around the second tier icon plural third tier icons each respectively related to a content or curator related to the subject matter represented by the second tier icon. When a second tier icon 114 is selected, the arrangement of first tier icons 108 may be removed from the 111 and the current video icon 106 reduced in size and moved, e.g., to the lower left corner of the display. The selected second tier icon 114 with its arrangement of (formerly third tier) related content/curator icons then takes the place of the current video icon and its arrangement of first tier icons. Likewise, when a first tier icon 108 is selected, the arrangement of first tier icons 108 may be removed from the UI and the current video icon 106 reduced in size and moved, e.g., to the lower left corner of the display. The selected first tier icon 108 with its arrangement of related content/curator (formerly second tier) icons then takes the place of the current video icon and its arrangement of first tier icons. When an icon is selected, video input to the display may be changed to content represented by the second tier icon. Without limitation, the change may be effected by, e.g., accessing an Internet link associated with the selected icon and streaming video from the link.

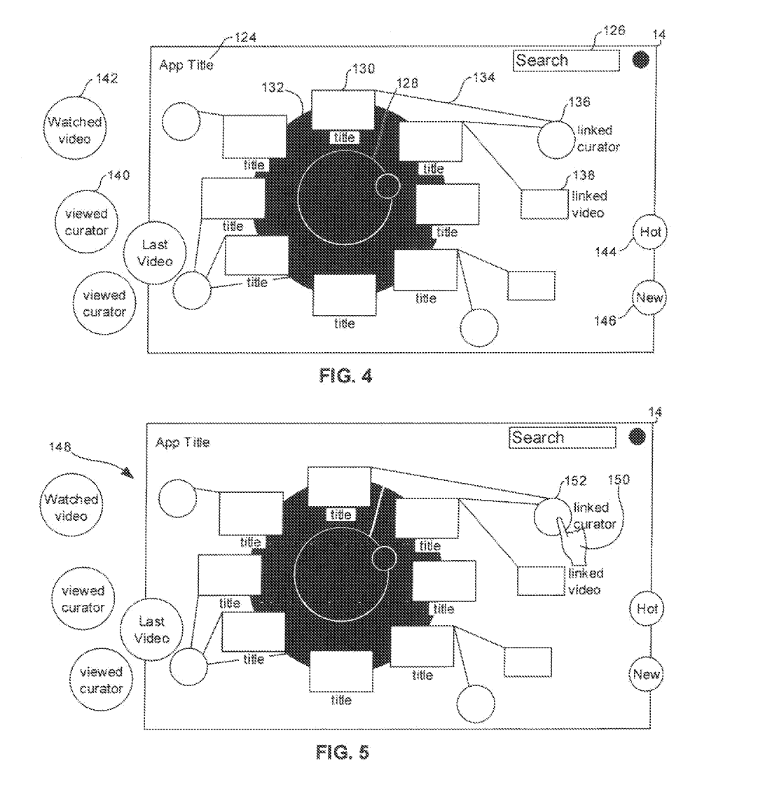

FIGS. 4-9 show schematic examples of the UI 104 shown in FIG. 3. In FIG. 4, in the example shown an application title 124 may be presented in the upper left corner of the display 14 indicating a name of the application being invoked. A search term entry box 126 may be presented in the upper right corner to receive search terms input a user, responsive to which an internet and/or electronic program guide (EPG) search may be executed for content and/or curators matching the search terms.

A current video icon 128 may be presented according to disclosure above. First tier icons 130 may surround the current video icon 128 and may be connected to each other by arcuate lines 132, although the lines 132 may be straight. Lines 134 may extend from respective first tier icons 130 to respective second tier content icons 136 representing content or second tier curator icons 138 representing a respective curator related to the content or curator of the respective first tier icon 130.

FIG. 4 schematically illustrates that the processor executing the UI may maintain in memory icons 140, 142 representing previously viewed curators and content that have been moved off the visible portion of the UI owing to selection of an icon as described above. The icon 143 representing the immediately prior viewed content may appear as shown on the left edge of the UI, without its surrounding arrangement of icons representing content/curators related to the immediately prior-viewed content. Icons 144, 146 may appear on the right edge of the display representing content designated by a content provider as being “new” or popular (“hot”).

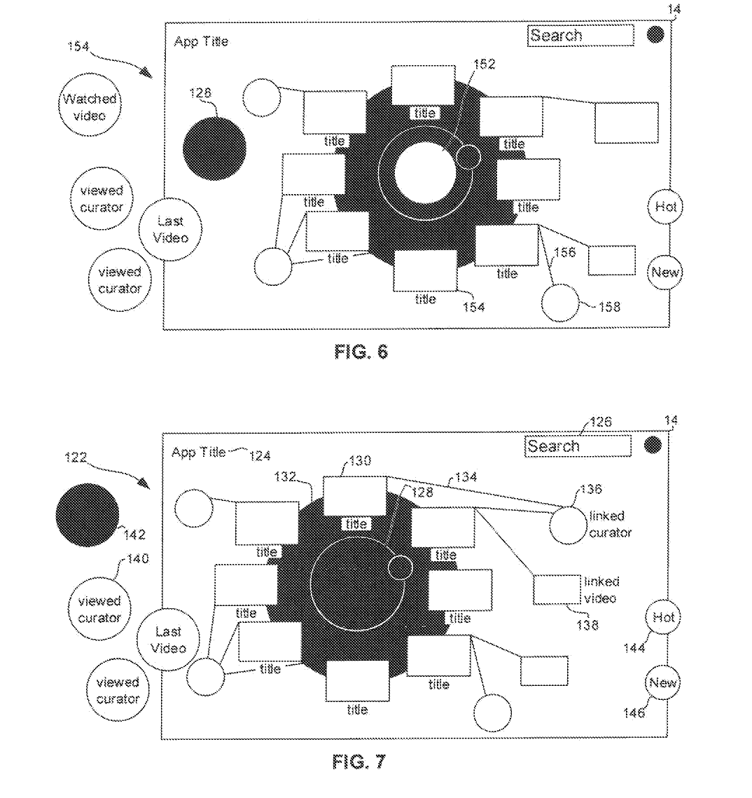

FIG. 5 illustrates a modified UI 148 in which a person 150 has selected as by touching, a second tier icon 152. As shown in FIG. 6, this causes the current video icon 128 to move to the left side of the display and its arrangement of first tier icons removed, with the selected second tier icon 152 moving into its place and assuming the role of the current video icon with an arrangement of first tier icons 154 surrounding it. The (new) first tier icons 154 may be connected by lines 156 to (new) second tier icons 158. The video input to the display is changed from that represented by the (former) current video icon 128 to that represented by the (newly selected) icon 152.

FIG. 7 illustrates that if the former current video icon 128 is selected from FIG. 6, it resumes its former place as shown in FIG. 4, along with its enlarged rendering and arrangement of first tier icons.

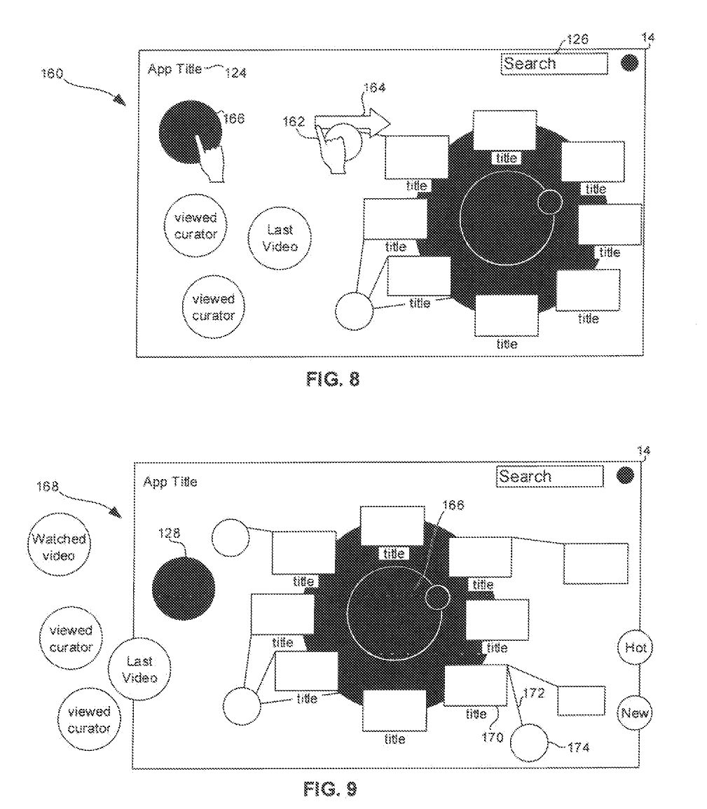

FIG. 8 shows a UI 160 in which a user 162 has swiped right as indicated by the arrow 164 to scroll onscreen icons representing previously viewed content. In this way, the person can review what be has viewed previously. A person may select a previously viewed icon 166 in FIG. 8 to cause the UI 168 of FIG. 9 to appear, in which be previously viewed icon 166 is moved toward the center of the display and surrounded by first tier icons 170 representing related content, one or more which according to principles above may be connected by a line 172 to a second tier icon 174 representing content or curator related to the first tier icon 170 from which the line 172 extends.

The above methods may be implemented as software instructions executed by a processor, suitably configured application specific integrated circuits (ASIC) or field programmable gate array (FPGA) modules, or any other convenient manner as would be appreciated by those skilled in those art. Where employed, the software instructions may be embodied in a non-transitory device such as a CD Rom or Flash drive. The software code instructions may alternatively be embodied in a transitory arrangement such as a radio or optical signal, or via a download over the internet.

It will be appreciated that whilst present principals have been described with reference to some example embodiments, these are not intended to be limiting, and that various alternative arrangements may be used to implement the subject matter claimed herein.

What is claimed is:

1. A computer device comprising:
at least one computer readable storage medium with instructions executable by a processor;
at least one processor configured for accessing the computer readable storage medium to execute the instructions to configure the processor for:
presenting on a display a user interface (UI) comprising a current video icon representing a current video input to the display;
presenting on the UI, around the current video icon, an arrangement of plural first tier icons, the first tier icons including content icons each representing a respective content related to the current video, and/or at least one curator icon representing a respective curator related to the current video;
presenting on the UI at least one second tier icon and at least one line extending from one of the first tier icons to the second tier icon, the second tier icon representing subject matter including content and/or a curator related to content represented by the first tier icon from which the line extends;
receiving a user selection of the second tier icon; and
responsive to the selection, presenting around the second tier icon plural third tier icons each respectively related to a content or curator related to the subject matter represented by the second tier icon.

2. The device of claim 1, wherein a content icon has a different shape than a curator icon.

3. The device of claim 1, wherein a curator icon represents a provider of content.

4. The device of claim 1, wherein the instructions when executed by the processor configure the processor for:
responsive to the selection of the second tier icon, removing the arrangement of first tier icons from the UI and moving the current video icon.

5. The device of claim 1, wherein the instructions when executed by the processor configure the processor for:
responsive to the selection of the second tier icon, changing video input to the display to content represented by the second tier icon.

6. The device of claim 1, wherein the arrangement of first tier icons defines a circle.

7. The device of claim 1, wherein a content icon includes a rectangle and a curator icon includes a circle.

8. A computer device comprising:
at least one computer readable storage medium that is not a carrier wave and that has instructions executable by a processor to configure the processor to:
present on a display a user interface (UI) comprising a current content icon representing a current content input to the display;
present an arrangement of plural first tier icons around the current content icon, each first tier icon representing respective subject matter related to the current content;
present on the UI at least one second tier icon and at least one line extending from one of the first tier icons to the second tier icon, the second tier icon representing subject matter related to content represented by the first tier icon from which the line extends;
receive a user selection of the second tier icon; and
responsive to the selection, present around the second tier icon plural third tier icons each respectively related to subject matter in turn related to the subject matter represented by the second tier icon.

9. The device of claim 8, wherein an icon representing a piece of content has a different shape than an icon representing a curator of content.

10. The device of claim 8, wherein an icon representing a curator represents a provider of content.

11. The device of claim 8, wherein the instructions when executed by the processor configure the processor to:
responsive to the selection of the second tier icon, remove the arrangement of first tier icons from the UI and move the current content icon.

12. The device of claim 8, wherein the instructions when executed by the processor configure the processor to:
responsive to the selection of the second tier icon, change video input to the display to content represented by the second tier icon.

13. The device of claim 8, wherein the arrangement of first tier icons defines a circle.

14. The device of claim 8, wherein an icon representing content includes a rectangle and an icon representing a content curator includes a circle.

15. A method comprising:
presenting on a display a user interface (UI) that links additional content and curators of videos by connecting, using lines, first tier icons to show connections to second tier icons also presented on the UI, the first tier icons surrounding a current content icon;
removing the lines from the UI after a predetermined period;
receiving selection of a second tier icon on the UI;
responsive to the selection, opening a new circle of content icons on the UI at least some of which are depicted on the UI as having connections to tertiary icons representing respective subject matter such that a user can discover new content that has relevancy to what the user is currently viewing.

16. The method of claim 15, comprising, after removing the lines, presenting the lines again responsive to navigation of the UI.

17. The method of claim 15, comprising presenting an icon representing a piece of content with a different shape than an icon representing a curator of content.

18. The method of claim 15, comprising:
responsive to the selection of the second tier icon, removing the first tier icons from the UI and moving the current content icon.

19. The method of claim 15, comprising:
responsive to the selection of the second tier icon, changing video input to the display to content represented by the second tier icon.
